(19) United States
(12) Patent Application Publication
(10) Pub. No.: US 2014/0313760 A1
(43) Pub. Date: Oct. 23, 2014

(54) VEHICULAR LAMP

(71) Applicant: KOITO MANUFACTURING CO., LTD., Tokyo (JP)

(72) Inventor: Takayuki YAGI, Shizuoka-shi (JP)

(73) Assignee: KOITO MANUFACTURING CO., LTD., Tokyo (JP)

(21) Appl. No.: 14/252,077

(22) Filed: Apr. 14, 2014

(30) Foreign Application Priority Data
Apr. 22, 2013 (JP) 2013-089073

(51) Int. Cl. F21S 8/10

(52) U.S. Cl. CPC F21S 48/1736; F21S 48/13; F21S 48/125
USPC 362/520

(57) ABSTRACT

In a plurality of light source units (20A, 20BL, 20BR), which are of a projector-type vehicular lamp and provided more towards a rear side than the rear side focal point (F) of a projection lens (12), the luminance of a light-emitting element (22A) of the first light source unit (20A) being set to a value higher than the luminance of a light-emitting element (22B) of each of second light source units (20BL, 20BR), so that in a low-beam light distribution pattern formed by the radiated light from the vehicular lamp, an area of high-intensity light is formed with sufficient brightness by the radiated light from the first light source unit (20A), and a diffusion region is formed by the radiated light from the second light source units (20BL, 20BR).

### BACKGROUND OF THE INVENTION

1. Field of the Invention

The present invention relates to a projector-type vehicular lamp, and more particularly, to a vehicular lamp including a plurality of light source units.

2. Description of the Related Art

Generally, in projector-type vehicular lamps, a light distribution pattern is formed by inverting and projecting a light source image formed on a rear side focal plane of a projection lens towards the front.

In the projector-type vehicular lamp disclosed in Japanese Patent Application Laid-Open (Kokai) No. 2010-86969 a plurality of light source units are provided more towards a rear side than the rear side focal point of the projection lens of the lamp.

Each of the light source units of this Japanese Patent Application Laid-Open (Kokai) No. 2010-86969 has a configuration in which light from the light source is reflected to the projection lens by a reflector.

If the lamp configuration described in Japanese Patent Application Laid-Open (Kokai) No. 2010-86969 is adopted, a whole light distribution pattern can be formed as a synthetic light distribution pattern of a plurality of light distribution patterns formed by the radiated light from the plurality of light source units.

Japanese Patent Application Laid-Open (Kokai) No. 2010-86969 describes that the degree of condensation of light of some reflectors is enhanced so as to form a small and bright light distribution pattern.

However, there is naturally a limit to the degree of condensation in the configuration in which the degree of condensation of the reflectors is enhanced in this way. Therefore, it is difficult to form an area of high-intensity light of the whole light distribution pattern with brightness higher than a predetermined value using a light distribution pattern in which the degree of condensation is enhanced.

### BRIEF SUMMARY OF THE INVENTION

The present invention is made in view of such circumstances as described above, and an object thereof is to provide a vehicular lamp that can sufficiently secure the brightness of an area of high-intensity light in a light distribution pattern formed by the radiated light from a projector-type vehicular lamp.

The present invention achieves the above object by the following configuration of a light source.

More specifically, a vehicular lamp according to the present invention comprises a projection lens and a plurality of light source units provided more towards a rear side than the rear side focal point of the projection lens; and each of the light source units includes a light source and a light control member that controls the light from the light source, and in the plurality of light source units, the luminance of the light source of a first light source unit is set to a value higher than the luminance of the light source of a second light source unit.

The type of the above-described “light source” is not particularly limited, and for example, a light-emitting element such as a light-emitting diode or a laser diode, a light source valve, or the like can be adopted. In that case, it is preferable to use the laser diode as “the light source of the first light source unit,” and to use the light-emitting diode as “the light source of the second light source unit.”

The specific configuration of the above-described “light control member” is not particularly limited, and for example, a reflector, a lens, or the like can be adopted.

The specific shape of a whole light distribution pattern formed by the radiated light from the above-described “plurality of light source units” is not particularly limited.

It is also possible to adopt a configuration in which the lamp uses light source units other than the first and second light source units as the above-described “plurality of light source units”.

As seen from the above, the vehicular lamp according to the present invention is constituted by a projector type lamp in which the plurality of light source units are provided more towards the rear side than (or provided behind) the rear side focal point of the projection lens, and in the plurality of light source units, the luminance of the light source of the first light source unit is higher than the luminance of the light source of the second light source unit. Accordingly, the following functional effects can be obtained.

In the light distribution pattern formed by the radiated light from the vehicular lamp, an area of high-intensity light can be easily formed with sufficient brightness by the radiated light from the first light source unit, and a diffusion region can be easily formed by the radiated light from the second light source units.

As seen from the above, according to the present invention, the brightness of the area of high-intensity light can be sufficiently secured in the light distribution pattern formed by the radiated light from the projector-type vehicular lamp.

In the above-described configuration, when a light-emitting element is used as the light source of each of the light source units, the area of high-intensity light can be easily prevented from becoming large more than necessary by adopting a configuration in which the light-emitting surface of the light-emitting element of the first light source unit is formed with a size smaller than that of the light-emitting surface of the light-emitting element of the second light source unit.

In the above-described configuration, when the light control member of each of the light source units is a reflector that reflects the light emitted from the light source towards the projection lens. In this structure, the utilization efficiency of the light emitted from the light source can be enhanced, and the size or brightness of the light distribution patterns that are formed by the radiated light from the respective light source units can be adjusted to some extent by the shape of the reflecting surfaces of the reflectors. Accordingly, the brightness of the area of high-intensity light in the whole light distribution pattern can be further enhanced.

In this case, a mirror member that has an upward reflecting surface for reflecting upward a portion of reflected light from the reflector of each of the light source units can be provided behind the projection lens, and the front end edge of the upward reflecting surface can be formed so as to pass through the rear side focal point of the projection lens or its vicinity. According to this structure, the light distribution pattern having cut-off lines at its upper end portion can be efficiently formed as the whole light distribution pattern.

### BRIEF DESCRIPTION OF THE SEVERAL VIEWS OF THE DRAWINGS

FIG. 1 is a plan view of a vehicular lamp according to one embodiment of the present invention.

FIG. 2 is a sectional view taken along the line 2-2 of FIG. 1.

FIG. 3 is a sectional view taken along the line 3-3 of FIG. 1.

FIG. 4 perspectively shows a low-beam light distribution pattern formed on an imaginary vertical screen 25 m in front of a vehicle mounted with the lamp of the present invention, the pattern being formed by the light radiated from the vehicular lamp of the present invention.

FIG. 5 is a view similar to FIG. 2, showing a modification example of the embodiment of the present invention.

### DETAILED DESCRIPTION OF THE INVENTION

Hereinafter, an embodiment of the present invention will be described with reference to the accompanying drawing.

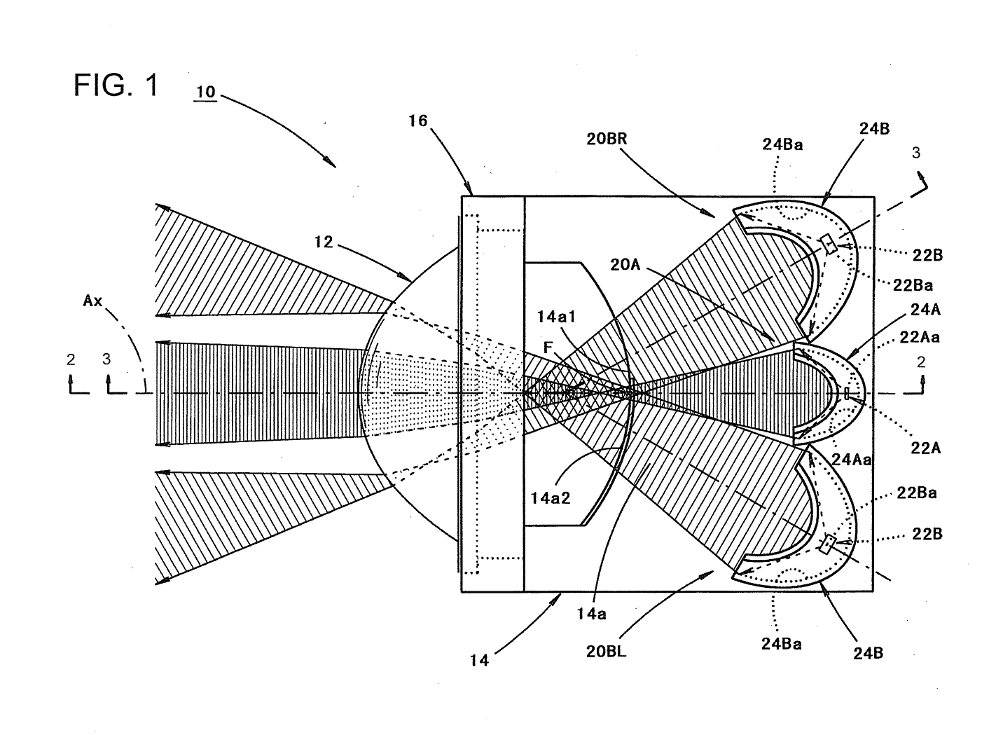

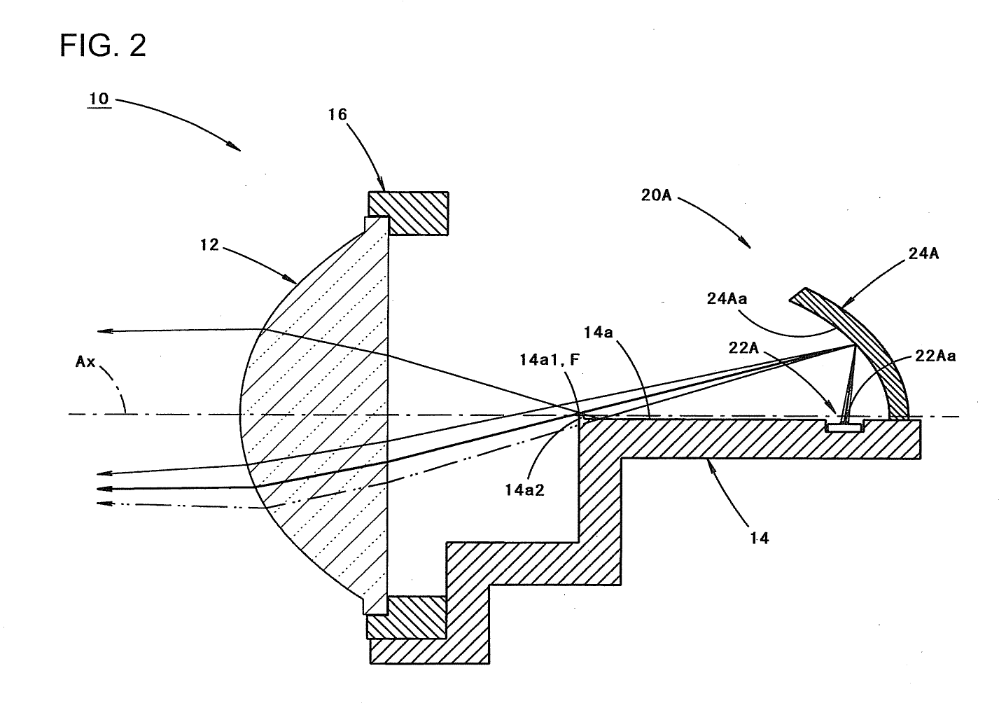

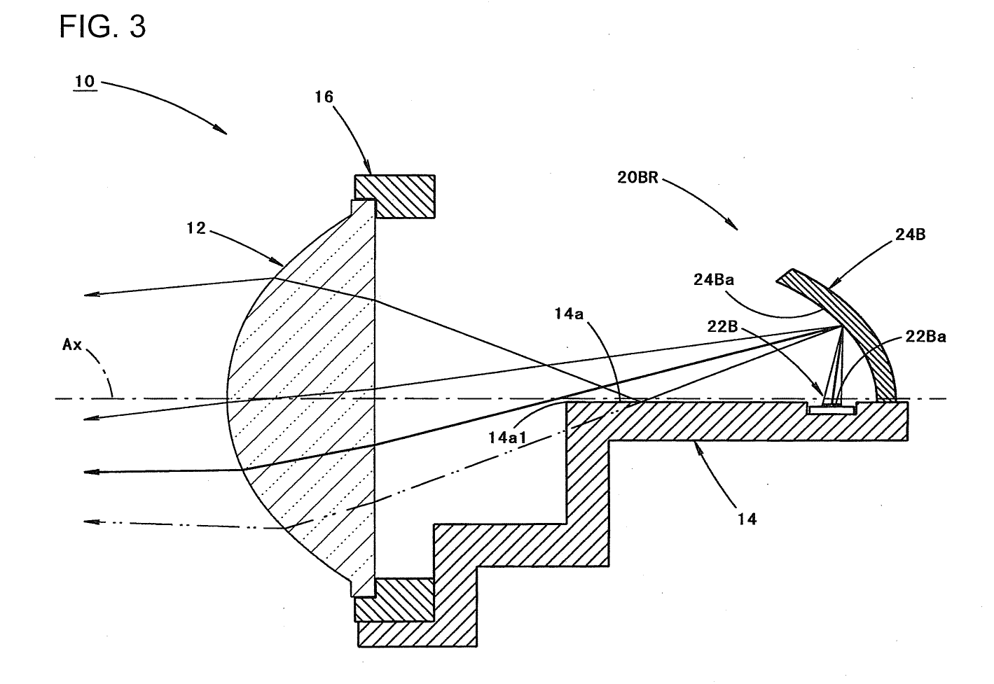

FIG. 1 is a plan view showing a vehicular lamp 10 of the embodiment of the present invention. FIG. 2 is a sectional view taken along the line 2-2 of FIG. 1, and FIG. 3 is a sectional view taken along the line 3-3 of FIG. 1.

As shown in these drawings, the vehicular lamp 10 of the shown embodiment is configured to include a projection lens 12, a first light source unit 20A and two second light source units 20BL, 20BR that are provided more towards a rear side than the rear side focal point F of the projection lens 12, and a mirror member 14 having an upward reflecting surface 14a.

In this structure, all of the first light source unit 20A and the two second light source units 20BL, 20BR are supported by the mirror member 14, and the projection lens 12 is supported by the mirror member 14 via a lens holder 16.

The vehicular lamp 10 is a lamp unit that is incorporated in a head lamp and is used as a portion thereof. In the state that the lamp 10 is incorporated in the head lamp, the vehicular lamp 10 is provided with an optical axis Ax of the projection lens 12 extending in a downward direction of about 0.5 to 0.6° with respect to the vehicular longitudinal direction.

The projection lens 12 is a planoconvex aspheric lens in which the front side surface is a convex surface and the rear side surface is a flat plane, and it projects a light source image, which is formed on a rear side focal plane that is a focal plane including the rear side focal point F, onto an imaginary vertical screen ahead of the lamp as an inverted image.

The first light source unit 20A includes a light-emitting element 22A, and a reflector 24A that is provided so as to cover the light-emitting element 22A from the upper side and reflects the light from the light-emitting element 22A towards the projection lens 12.

The light-emitting element 22A is a light-emitting chip of a white laser diode, and has a laterally oblong-shaped small light-emitting surface 22Aa.

The light-emitting surface 22Aa is constituted as a high-luminance light-emitting surface. Also, the light-emitting element 22A is provided so that the light-emitting surface 22Aa faces upward slightly below the optical axis Ax.

The reflecting surface 24Aa of the reflector 24A is constituted by a substantially ellipsoidal curved surface that has a major axis coaxial with the optical axis Ax and has a first focal point at the center of light emission of the light-emitting element 22A. The vertical sectional shape of the reflecting surface 24Aa along its major axis is, as seen from FIG. 2, set to be an elliptical shape that has a second focal point at a point located slightly ahead (front) of the rear side focal point F, and its eccentricity is set so as to gradually increase from the vertical section towards the horizontal section. Accordingly, the reflector 24A is adapted such that the light from the light-emitting element 22A converges on the point located slightly ahead of the rear side focal point F within the vertical section, and the convergence position is shifted slightly forward within the horizontal section.

The two second light source units 20BL, 20BR are, as seen from FIG. 1, provided on the left and right sides of the first light source unit 20A in a symmetrical positional relationship with respect to the optical axis Ax.

Each of the second light source units 20BL, 20BR includes a light-emitting element 22B, and a reflector 24B. The reflector 24B is provided so as to cover the light-emitting element 22B from the upper side and reflects the light from the light-emitting element 22B towards the projection lens 12.

The light-emitting element 22B is a light-emitting chip of a white light-emitting diode, and it has a laterally oblong-shaped light-emitting surface 22Ba.

The light-emitting surface 22Ba has an appearance shape that is similar to a square as compared to the light-emitting surface 22Aa of the light-emitting element 22A, and it is considerably larger (twice or more) in size than the light-emitting surface 22Aa. The light-emitting surface 22Ba is constituted as a low-luminance light-emitting surface as compared to the light-emitting surface 22Aa of the light-emitting element 22A. Also, the light-emitting element 22B is provided so that the light-emitting surface 22Ba faces upward slightly below the horizontal surface including the optical axis Ax.

The reflecting surface 24Ba of the reflector 24B of the second light source unit 20BL located on the left side is a substantially ellipsoidal curved surface that has a major axis extending in a direction slanting rightward towards the front and that has a first focal point at the center of light emission of the light-emitting element 22B. On the other hand, the reflecting surface 24Ba of the reflector 24B of the second light source unit 20BR located on the right side is a substantially ellipsoidal curved surface that has a major axis extending in a direction slanting leftward towards the front and that has a first focal point at the center of light emission of the light-emitting element 22B.

The vertical sectional shape of the reflecting surface 24Ba of the reflector 24B of each of the second light source units 20BL, 20BR along its major axis is, as seen from FIG. 3, set to be an elliptical shape that has a second focal point at a point located slightly ahead of the rear side focal point F, and its eccentricity is set so as to gradually increase from the vertical section towards the horizontal section. The degree of increase of the eccentricity is set so as to be larger than that of the reflector 24A. Accordingly, the reflector 24B of each of the second light source units 20BL, 20BR is adapted such that the light from each light-emitting element 22B converges on the point located slightly ahead of the rear side focal point F within the vertical section and the convergence position is shifted considerably forward within the horizontal section.

The upward reflecting surface 14a of the mirror member 14 is formed by mirror surface treatment using aluminum evaporation or the like applied to the upper surface of the mirror member 14. The upward reflecting surface 14a is provided so that the front end edge 14a1 passes through the rear side focal point F. As seen from FIG. 1, the front end edge 14a1 extends while curving towards the front along the meridional image surface of the projection lens 12, from the rear side focal point F towards the right and left sides in a plan view.

The mirror member 14 is adapted such that, as seen from FIGS. 2 and 3, a portion of reflected light from each of the reflectors 24A, 24B towards the projection lens 12 is reflected upward at the upward reflecting surface 14a so as to be incident on the projection lens 12 and the incident light is emitted out from the projection lens 12 as downward light. The low-beam light distribution pattern for the left side light distribution (this will be described below) is formed by the emission light from the projection lens 12.

The upward reflecting surface 14a is formed so as to extend along the horizontal plane slightly below the optical axis Ax. However, a vertical wall portion 14a2 that protrudes upward is formed at a portion of a front end of the upward reflecting surface 14a, which is on the left side (the right side when viewed from the front of the lamp) of the rear side focal point F.

The vertical wall portion 14a2 is, as shown in FIG. 1, formed so as to extend with a narrow width along the front end edge 14a1 in a plan view. The vertical wall portion 14a2 extends with a constant height from a position on the optical axis Ax towards the left side, and it also extends obliquely downward from the position on the optical axis Ax towards the right side to the upward reflecting surface 14a.

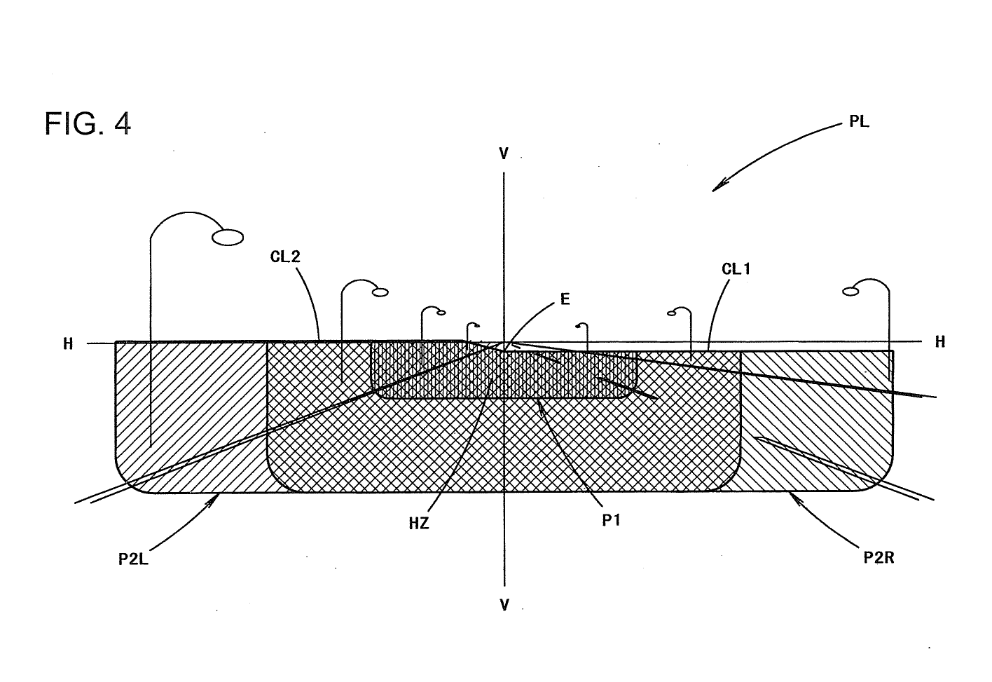

FIG. 4 perspectively shows a low-beam light distribution pattern PL formed by the light radiated from the vehicular lamp 10 on the imaginary vertical screen provided at a position 25 m in front of the vehicle that has the lamp 10.

The low-beam light distribution pattern PL is a low-beam light distribution pattern for left side light distribution, and an upper end edge thereof has cut-off lines CL1, CL2 that are formed in a stepped fashion in the left-right direction. The cut-off lines CL1, CL2 extend in the horizontal direction in a stepped fashion in the left-right direction with line V-V serving as a boundary. The line V-V vertically passes through line H-V which is a vanishing point to the forward direction of the lamp. An opposite-lane-side portion on the right of the line V-V is formed as a lower step cut-off line CL1, and a self-lane-side portion on the left of the line V-V is formed as an upper step cut-off line CL2 that is a step higher than the lower step cut-off line CL1 due to the inclination portion.

The low-beam light distribution pattern PL is formed by projecting, as inverted projection images, images of the light-emitting elements 22A, 22B, which are formed on the rear side focal plane of the projection lens 12 by the radiated light from the first and second light source units 20A, 20B, on the above-described imaginary vertical screen with the projection lens 12, and cut-off lines CL1, CL2 thereof are formed as an inverted projection image of the front end edge 14a1 of the upward reflecting surface 14a of the mirror member 14.

In the low-beam light distribution pattern PL, the elbow point E that is an intersection point between the lower step cut-off line CL1 and the line V-V is located about 0.5 to 0.6° below the line H-V. This is because the optical axis Ax extends in the downward direction of about 0.5 to 0.6° with respect to the vehicular longitudinal direction.

The low-beam light distribution pattern PL is formed as a synthetic light distribution pattern of a first light distribution pattern P1 and two second light distribution patterns P2L, P2R.

The first light distribution pattern P1 is a light distribution pattern formed by the radiated light from the first light source unit 20A.

The first light distribution pattern P1 extends in an elongated shape in the lateral direction with the elbow point E as a center, and it is formed as a considerably small and bright light distribution pattern as compared to the two second light distribution patterns P2L, P2R. Accordingly, the first light distribution pattern P1 forms an area of high-intensity light (that is, hot zone) HZ of the low-beam light distribution pattern PL.

The first light distribution pattern P1 extends in the elongated shape in the lateral direction because the light-emitting surface 22Aa of the light-emitting element 22A is formed in a horizontally oblong shape.

Further, the first light distribution pattern P1 is formed as the small and bright light distribution pattern because the size of the light-emitting surface 22Aa of the light-emitting element 22A is small and luminance is high (when compared to the size and luminance of the light-emitting element 22B) and because the convergence position of the reflected light from the reflector 24A within the horizontal section is not displaced so much from the rear side focal point F of the projection lens 12 to the front side.

The two second light distribution patterns P2L, P2R are light distribution patterns formed by the radiated light from the two second light source units 20BL, 20BR.

The two second light distribution patterns P2L, P2R are (when compared to the first light distribution pattern P1) large light distribution patterns that extend in an elongated shape in the lateral direction with the elbow point E as a center, and they are formed in a symmetrical positional relationship with respect to the line V-V so as to partially overlap each other.

The light distribution pattern P2L located on the left side is formed by the radiated light from the right second light source unit 20BR, and the light distribution pattern P2R located on the right side is formed by the radiated light from the left second light source unit 20BL.

Each of the light distribution patterns P2L, P2R is formed as the light distribution patterns that extend in the elongated shape in the lateral direction because the light-emitting surface 22Ba of the light-emitting element 22B is formed in a laterally oblong shape.

Further, each of the light distribution patterns P2L, P2R is formed as the large light distribution patterns because the size of the light-emitting surface 22Ba of the light-emitting element 22B is large (when compared to the size of the light-emitting element 22A) and because the convergence position of the reflected light from the reflector 24B within the horizontal section is considerably displaced from the rear side focal point F of the projection lens 12 to the front side.

Next, the functional effects of the shown embodiment will be described.

The vehicular lamp 10 according to to the embodiment described above is constituted as a projector type lamp in which the plurality of light source units 20A, 20BL, 20BR are provided more towards the rear side than (or behind) the rear side focal point F of the projection lens 12. In the plurality of light source units 20A, 20BL, 20BR, the luminance of the light-emitting element 22A that is a light source of the first light source unit 20A is set to a value higher than the luminance of the light-emitting element 22B that is a light source of each of the second light source units 20BL, 20BR. Thus, the following functional effects can be obtained.

In the low-beam light distribution pattern PL serving as a whole light distribution pattern formed by the radiated light from the vehicular lamp 10, the area of high-intensity light HZ can be formed with sufficient brightness by the radiated light from the first light source unit 20A, and a diffusion region can be formed by the radiated light from the second light source units 20BL, 20BR.

Thus, according to the shown embodiment, in the low-beam light distribution pattern PL formed by the radiated light from the projector-type vehicular lamp 10, the brightness of the area of high-intensity light HZ can be sufficiently secured.

In the structure of the shown embodiment, the light-emitting surface 22Aa of the light-emitting element 22A of the first light source unit 20A is smaller in size than the light-emitting surfaces 22Ba of the light-emitting elements 22B of the other two second light source units 20BL, 20BR. Accordingly, the area of high-intensity light HZ can be prevented from becoming large more larger than necessary.

Additionally, in the embodiment above, the light control members that control the light from the light-emitting elements 22A, 22B in the first light source unit 20A and each of the second light source units 20BL, 20BR are constituted by the reflectors 24A, 24B that reflect the light emitted from the light-emitting elements 22A, 22B towards the projection lens 12. Thus, the utilization efficiency of the light emitted from the light-emitting elements 22A, 22B is enhanced, and the size or brightness of the light distribution patterns P1, P2L, P2R that are formed by the radiated light from the first light source unit 20A and each of the second light source units 20BL, 20BR can be adjusted to some extent by the shape of the reflecting surfaces 24Aa, 24Ba of the reflectors 24A, 24B. Accordingly, the brightness of the area of high-intensity light HZ in the low-beam light distribution pattern PL is further enhanced.

Moreover, in the embodiment described above, the mirror member 14 has the upward reflecting surface 14a for reflecting upward a portion of the reflected light from each of the reflectors 24A, 24B of the first light source unit 20A and the second light source units 20BL, 20BR, and it is provided behind the projection lens 12, and the upward reflecting surface 14a is formed so that the front end edge 14a1 passes through the rear side focal point F of the projection lens 12. Accordingly, the low-beam light distribution pattern PL that has the cut-off lines CL1, CL2 at the upper end portion can be efficiently formed.

Although the above-described embodiment has such a configuration that only the first light source unit 20A and the two second light source units 20BL, 20BR are provided more towards the rear side than the rear side focal point F of the projection lens 12, it is also possible to additionally use light source units other than these light source units so as to make the area of high-intensity light HZ brighter using the radiated light of the other light source units or to make the brightness of the diffusion region increase.

The above-described embodiment has such a configuration that the two second light source units 20BL, 20BR are provided as the second light source units, it is also possible to provide only one second light source unit.

Although the above-described embodiment has such a configuration that the light-emitting surface 22Aa of the light-emitting element 22A of the first light source unit 20A is formed smaller in size than the light-emitting surfaces 22Ba of the light-emitting elements 22B of the other two second light source units 20BL, 20BR, it is also possible to configure such that the light-emitting surface 22Aa and the light-emitting surface 22Ba are the same size.

In the above-described embodiment, the front end edge 14a1 of the upward reflecting surface 14a is arranged so as to pass through the rear side focal point F, and it is also possible to configure such that the upper end edge 14a1 passes through the vicinity of the rear side focal point F (for example, the upper vicinity or lower vicinity of the rear side focal point F).

In the above embodiment-described, the vehicular lamp 10 is configured so as to form the low-beam light distribution pattern PL for left side light distribution. However, even when the vehicular lamp forms a low-beam light distribution pattern for the right side light distribution or even when the vehicular lamp is configured so as to form a light distribution pattern having only a horizontal cut-off line at the upper end portion, the same functional effects can be obtained by adopting the same configuration as the embodiment described above.

Next, a modification example of the embodiment above will be described.

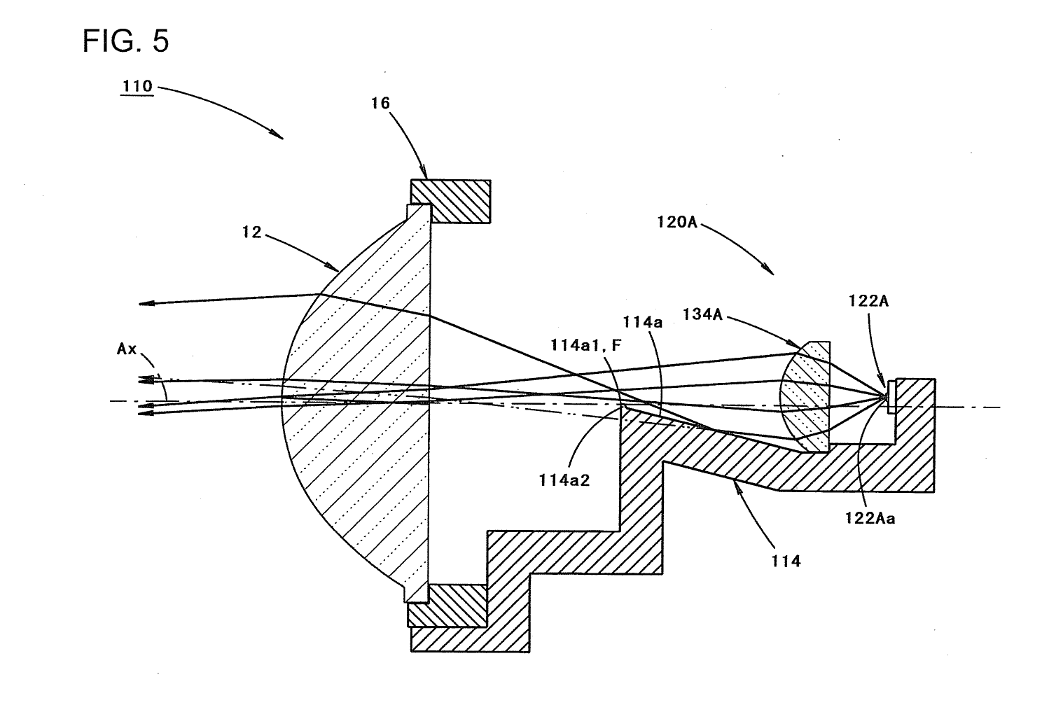

FIG. 5 is a view similar to FIG. 2, showing a vehicular lamp 110 according to the modification example.

As shown in FIG. 5, although the vehicular lamp 110 of this modification example is the same as that of the embodiment described above in terms of its basic configuration, the vehicular lamp 110 has a lens 134A (or a secondary lens 134A to the projection lens 12) instead of the reflector 24A of the above-described embodiment, as a light control member of a first light source unit 120A.

More specifically, in the first light source unit 120A, a light-emitting element 122A has a laterally oblong-shaped small light-emitting surface 122Aa, and the light-emitting surface 122Aa is constituted as a high-luminance light-emitting surface. and further, the light-emitting element 122A is provided so that the light-emitting surface 122Aa faces forward in the upper vicinity of the optical axis Ax.

The lens 134A is a planoconvex aspheric lens in which the front side surface is a convex surface, and the rear side surface is a flat plane. The lens 134A is provided so that the rear side focal point is located slightly ahead of the center of light emission of the light-emitting element 122A. Also, the lens 134A is adapted to emit the light emitted from the light-emitting element 122A towards the projection lens 12 such that the emitted light is somewhat converged in the vertical direction.

A mirror member 114 of the modification example is structured such that the upward reflecting surface 114a inclines obliquely downward towards the rear, and it is adapted to reflect a portion of the light emitted from the lens 134A upward so as to be incident on the projection lens 12. The configurations of a front end edge 114a1 and a vertical wall portion 114a2 of the mirror member 114 are the same as those of the mirror member 14 of the embodiment described above.

In this modification example, the second light source units (not shown) each including the same lens as the lens 134A of the first light source unit 120A are provided on both the right and left sides of the first light source unit 120A. However, the light-emitting surface of the light-emitting element of each of the second light source units is low in luminance and large in size as compared to the light-emitting surface 122Aa of the light-emitting element 122A.

In the configuration of the modification example, the area of high-intensity light HZ of the low-beam light distribution pattern PL has a sufficient brightness formed by the radiated light from the first light source unit 120A, and a diffusion region can be formed by the radiated light from the second light source units.

It is natural that the numerical values used as various dimensions in the above-described embodiment and its modification example are merely exemplary, and these numerical values may be appropriately set to different values.

In addition, the present invention is not limited to the configurations of the above-described embodiment and its modification example, and it is possible to adopt configurations other than the above-described various changes being added to.

1. A vehicular lamp comprising: a projection lens; and a plurality of light source units provided more towards a rear side than a rear side focal point of the projection lens, wherein
each of the light source units includes a light source, and a light control member that controls light from the light source, and
in the plurality of light source units including a first light source unit and a second light source unit, a luminance of the light source of the first light source unit is higher than a luminance of the light source of the second light source unit.

2. The vehicular lamp according to claim 1, wherein
a light-emitting element is used as the light source of each of the light source units, and
a light-emitting surface of the light-emitting element of the first light source unit is smaller in size than that of a light-emitting surface of the light-emitting element of the second light source unit.

3. The vehicular lamp according to claim 1 wherein
the light control member is a reflector that reflects the light from the light source towards the projection lens.

4. The vehicular lamp according to claim 3, wherein
a mirror member having an upward reflecting surface for reflecting upward a portion of a reflected light from the reflector of each of the light source units is provided behind the projection lens, and
a front end edge of the upward reflecting surface is formed so as to pass through the rear side focal point or a vicinity of the rear side focal point.

5. The vehicular lamp according to claim 1, wherein
the light control member is a secondary lens that emits the light from the light source towards the projection lens.

6. The vehicular lamp according to claim 5, wherein
a mirror member having an upward reflecting surface for reflecting upward a portion of a light from the secondary lens is provided behind the projection lens.
